(19) United States
(12) Patent Application Publication
(10) Pub. No.: US 2006/0246376 A1
(43) Pub. Date: Nov. 2, 2006

(54) Information recording medium, recording/reproducing method for the same, and information recording/reproducing apparatus

(75) Inventor: Seiji Nishino, Osaka-shi (JP)

Correspondence Address: HAMRE, SCHUMANN, MUELLER & LARSON P.C., P.O. BOX 2902-0902, MINNEAPOLIS, MN, 55402, US

(73) Assignee: MATSUSHITA ELECTRIC INDUSTRIAL CO., LTD., Kadomi-shi (JP)

(21) Appl. No.: 10/558,131

(22) PCT Filed: May 25, 2004
(86) PCT No.: PCT/JP04/07433

§ 371 Date: Nov. 23, 2005

(30) Foreign Application Priority Data
May 26, 2003 (JP) 2003-147243

(51) Int. Cl. G11B 7/24

(52) U.S. Cl. 430/270.15; 430/19; 430/945; 428/64.1; 369/283

(57) ABSTRACT

An information recording medium includes a recording layer, in which information is recorded by two-photon absorption that occurs when recording light is focused on the recording layer. The recording layer (211, 212) contains a photosensitive polymer that includes a principal chain containing acrylate or methacrylate and a first side chain and a second side chain branched from the principal chain. The first side chain undergoes a cis-trans isomerization reaction upon absorption of the recording light, and the second side chain has a property of being oriented in about the same direction as a direction of the first side chain when the first side chain undergoes the cis-trans isomerization reaction.

### TECHNICAL FIELD

The present invention relates to an information recording medium, a recording/reproducing method for the same, and an information recording/reproducing apparatus.

### BACKGROUND ART

In recent years, in proportion to an increase in the volume of information, there is a strong demand for higher-capacity information recording media. It is effective for achieving higher-capacity information recording media to laminate recording layers multiply. FIG. 6 shows an information recording medium including a plurality of recording layers. As shown in FIG. 6, separation layers 53 and recording layers 51 that are translucent with respect to recording light and reproduction light are arranged alternately between a protective film 50 and a support substrate 56. This information recording medium enables information recording (primary light absorption recording) in the recording layers 51 by using a phase transition caused under the influence of heat generation that accompanies absorption of the recording light or a deformation.

However, when this recording medium includes, for example, 4 or more recording layers, there is strong attenuation of light transmitted through the recording layers 51. Accordingly, it is impossible for this information recording medium to include 4 or more recording layers 51, resulting in difficulty in achieving higher capacity.

Recently, information recording media that enable information recording by using multiphoton absorption are receiving attention (see, for example, JP 8(1996)-220688 A). An example is shown in FIG. 7. This information recording medium has, instead of the recording layers 51 of the information recording medium shown in FIG. 6, recording layers 52 that are substantially transparent with respect to recording light and reproduction light. In information recording using multiphoton absorption, electrons in a location of extremely strong optical electric field, that is, in the vicinity of a focal point 12, are excited, whereby a light absorption reaction occurs. No light absorption occurs in portions other than the vicinity of the focal point 12. A recording material that enables multiphoton absorption causes extremely small attenuation of transmitted light (recording light and reproduction light) and is substantially transparent with respect to the recording light and the reproduction light. Therefore, it is possible to provide an information recording medium including a large number of recording layers. In FIGS. 6 and 7, reference numeral 10 denotes an objective lens and 11 denotes converged light.

In information recording using two-photon absorption, a recording material has to meet the following conditions (1) and (2) in addition to the substantial transparency with respect to recording light and reproduction light. That is, (1) a portion of the recording material where light is focused is deformed into a bit shape by heat, and (2) the refractive index is changed by heat. A recording material for an information recording medium from which information can be erased is required to have the following property. That is, due to heat generation that accompanies two-photon absorption, (3) the bit-shaped deformation is removed by heat or (4) the changed refractive index returns to its initial value by heat. At present, information recording media using a change in the refractive index that accompanies a phase change between a crystalline phase and an amorphous phase are known. As a recording material, an oxide such as tellurium oxide or the like is used (see, for example, International Publication No. WO 03/102941).

However, although an oxide such as tellurium oxide or the like allows a phase change from a crystalline phase to an amorphous phase to be caused at a speed of practical level, it allows a phase change from an amorphous phase to a crystalline phase at an extremely low speed since this phase change requires a long time of thermal action. For example, although the phase change from a crystalline phase to an amorphous phase can be caused in about several n seconds, the phase change from an amorphous phase to a crystalline phase requires several m seconds of heating.

### DISCLOSURE OF INVENTION

An information recording medium of the present invention includes a recording layer, in which information is recorded by two-photon absorption that occurs when recording light is focused on the recording layer, wherein the recording layer contains a photosensitive polymer that includes a principal chain containing acrylate or methacrylate and a first side chain and a second side chain branched from the principal chain. The first side chain undergoes a cis-trans isomerization reaction upon absorption of the recording light, and the second side chain has a property of being oriented in about the same direction as a direction of the first side chain when the first side chain undergoes the cis-trans isomerization reaction.

A recording/reproducing method of the present invention for recording or reproducing information with respect to the information recording medium of the present invention includes: focusing the recording light on the recording layer so as to form a recorded bit; and irradiating the recorded bit with reproduction light so as to reproduce information.

Another recording/reproducing method of the present invention for recording or reproducing information with respect to the information recording medium of the present invention includes: focusing the recording light on the recording layer so as to form a recorded bit; and irradiating the recorded bit with reproduction light so as to reproduce information, wherein the recording light includes first light and second light, the second light has a polarization plane direction tilted substantially 45 degrees with respect to a polarization plane direction of the first light, and the polarization plane direction of either one of the first light and the second light coincides with the direction in which the optic axis of the photosensitive polymer is oriented, and the reproduction light has a polarization plane direction tilted substantially 90 degrees with respect to the polarization plane direction of either one of the first light and the second light.

An information recording/reproducing apparatus of the present invention for recording or reproducing information with respect to the information recording medium of the present invention includes: a light source for emitting recording light; a light source for emitting reproduction light; a half-wave plate through which the recording light and the reproduction light pass; and an objective lens for focusing the recording light and the reproduction light on the information recording medium, wherein the half-wave plate can be rotated so that assuming that the recording light that has passed through the half-wave plate has a predetermined polarization plane direction, the recording light emitted from the light source has a polarization plane direction tilted substantially 45 degrees with respect to the predetermined polarization plane direction, and assuming that the predetermined polarization plane direction is a direction Wp1 and the polarization plane direction tilted substantially 45 degrees with respect to the predetermined polarization plane direction is a direction Wp2, the reproduction light emitted from the light source has a polarization plane direction tilted substantially 90 degrees with respect to either one of the polarization plane direction Wp1 and the polarization plane direction Wp2.

Another information recording/reproducing apparatus of the present invention for recording or reproducing information with respect to the information recording medium of the present invention includes: a light source for emitting recording light; a light source for emitting reproduction light; a half-wave plate through which the recording light and the reproduction light pass; and an objective lens for focusing the recording light and the reproduction light on the information recording medium, wherein the half-wave plate can be rotated so that assuming that the recording light that has passed through the half-wave plate has a predetermined polarization plane direction, the recording light emitted from the light source has a polarization plane direction tilted substantially 45 degrees with respect to the predetermined polarization plane direction, and assuming that the predetermined polarization plane direction is a direction Wp1 and the polarization plane direction tilted substantially 45 degrees with respect to the predetermined polarization plane direction is a direction Wp2, either one of the polarization plane direction Wp1 and the polarization plane direction Wp2 coincides with the optic axis of the photosensitive polymer, and the reproduction light emitted from the light source has a polarization plane direction tilted substantially 90 degrees with respect to either one of the polarization plane direction Wp1 and the polarization plane direction Wp2.

### BRIEF DESCRIPTION OF DRAWINGS

FIG. 1 is a view showing a cross-sectional configuration of an exemplary information recording medium and a schematic configuration of an optical head of an information recording/reproducing apparatus of the present invention.

FIG. 2 is a diagram showing polarization plane directions of recording light and reproduction light irradiated to an information recording medium in which an optic axis is oriented randomly.

FIG. 3 is a diagram showing polarization plane directions of recording light and reproduction light irradiated to an information recording medium that is initialized so that an optic axis is oriented in a single direction.

FIG. 4 is a diagram showing spectral characteristics of a photosensitive polymer constituting the information recording medium shown in FIG. 1.

FIG. 5 is a diagram showing the relationship between the amount of light irradiated to the photosensitive polymer constituting the information recording medium shown in FIG. 1 and the absorptance of the photosensitive polymer with respect to the irradiated light.

FIG. 6 is a view showing a cross-sectional configuration of an exemplary conventional information recording medium.

FIG. 7 is a view showing a cross-sectional configuration of an exemplary conventional information recording medium.

### DESCRIPTION OF THE INVENTION

In the present specification, a polarization plane direction is a direction of vibration of an optical electric field, and lies in a plane perpendicular to a traveling direction of light.

In an exemplary information recording medium of the present invention, a first side chain and a second side chain covalently bonded to a principal chain have structures represented by the following Formulas (1) and (2), respectively. 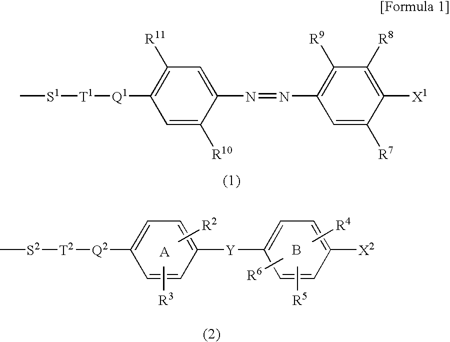
(in which S1 and S2 independently of one another are O or S atoms or the NR¹ radical; R¹ is hydrogen, C₁-C₆-alkyl or phenyl, and T¹ and T² independently of one another are the (CR¹, R¹²)ₙ radical, which optionally can be interrupted by —O—, —S—, —NR¹— or —OSiR¹₂O—, where n is an integer from 2 to 12; Q¹ and Q² independently of one another are —O—, —COO—, —OCO—, —CONR¹—, —NR¹CO—, —NR¹—, —O—C₆H₄—COO— or —O—C₆H₄—CONR¹—, whereby additionally the combinations S¹R¹Q¹ and S²T²Q² independently of one another can be 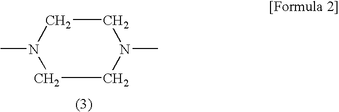
R² to R⁶ independently of one another are hydrogen, halogen, C₁-C₄-alkyl, C₁-C₄-alkoxy, CF₃, nitro, SO₂CH₃, SO₂NH₂ or cyano, where at least one of the substituents R² to R⁶ must be other than hydrogen; R⁷ to R⁹ independently of one another are hydrogen, C₁-C₆-alkyl, hydroxyl, Cₗ-C₆-alkoxy, phenoxy, C₁-C₆-alkylthio, phenylthio, halogen, CF₃, CCl₃, CBr₃, nitro, cyan, C₁-C₆-alkylsulfonyl, phenylsulfonyl, COOR¹, aminosulfonyl, C₁-C₆-alkylaminosulfonyl, phenylaminosulfonyl, aminocarbonyl, C₁-C₆-alkylaminocarbonyl, or phenylaminocarbonyl; R¹⁰ is hydrogen, halogen, C₁-C₆-alkyl, hydroxyl, C₁-C₆-alkoxy, phenoxy, C₁-C₄-acylamino, or C₁-C₄-alkylsulfonylamino;

R¹¹ is hydrogen, halogen, C₁-C₆-alkyl, hydroxyl, C₁-C₆-alkoxy, or phenoxy; Y is a direct bonding, —COO—, —OCO—, —CONH—, —NHCO—, —O—, —NH—, —N(CH₃), or —N═—; and X¹ and X² independently of one another are each hydrogen, hydroxyl, mercapto, CF₃, CCl₃, CBr₃, halogen, cyan, nitro, COOR¹, C₁-C₆-alkyl, C₅-C₁₂-cycloalkyl, C₁- C₁₂-alkoxy, C₁-C₁₂-alkylthio, C₆-C₁₂-aryl, C₆-C₁₂-aryloxy, C₆-C₁₂-arylthio, C₁-C₆-alkylsulfonyl, C₆-C₁₂-arylsulfonyl, aminosulfonyl, C₁-C₆-alkylaminosulfonyl, phenylaminosulfonyl, aminocarbonyl, C₁-C₆-alkylaminocarbonyl, phenylaminocarbonyl, N(R¹², R¹³), NH—CO—R¹², NH—SO₂-R^{12,} NH—CO—N(R¹, R²), NH—CO—O—R¹² or SO₂—CF₃, wherein R¹² and R¹3 independently of one another are hydrogen, C₁-C₄-alkyl or phenyl; with the proviso that, if R⁷ to R¹¹ denote hydrogen and ring B is substituted by C₁-C₄-alkyl, C₁-C₄-alkoxy, nitro or cyano, at least one second substituent is also present in the ring A-Y-ring B system.) Each of the side chains has at least one structure represented by the formula satisfying the above-mentioned conditions.

Alternatively, a photosensitive polymer may have a structure in which at least one of Q¹ and Q² is —O—C₆H₄—COO— or —O—C₆H₄—CONR—.

Such photosensitive polymers can be manufactured by a method described in JP 8(1996)-109226 A.

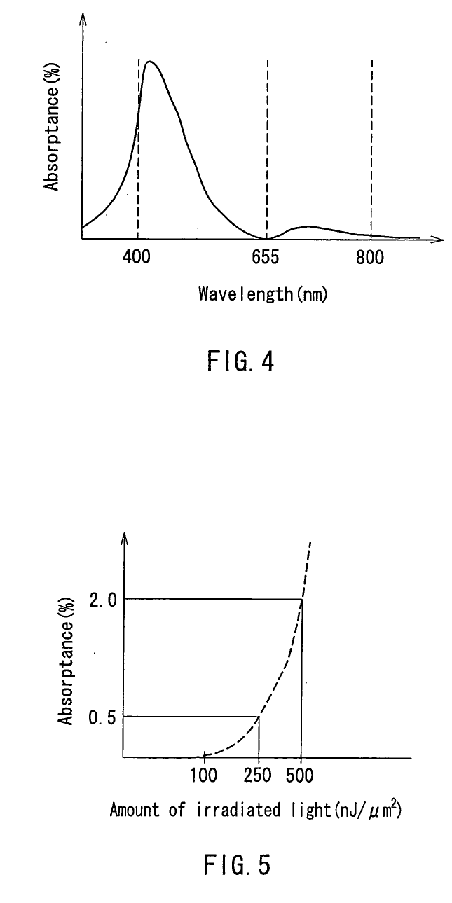

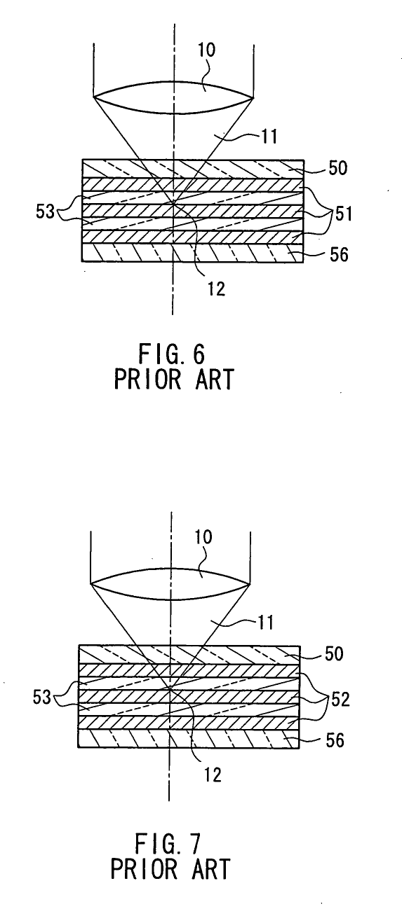

FIG. 4 shows spectral characteristics of a photosensitive polymer used in an exemplary information recording medium of the present embodiments. For measurement of the spectral characteristics shown in FIG. 4, a laminate in which a recording layer (thickness: 1 μm) containing the photosensitive polymer was laminated on a substrate made of polycarbonate was used. The spectral characteristics were measured with a spectroscope. The recording layer was obtained so as to have a thickness of about 1 μm by applying the photosensitive polymer onto the substrate by spin coating, followed by drying. As the photosensitive polymer, a photosensitive polymer in which a first side chain contained 3-bromo-4-[6-(2-methylpropenoyl) hexoxy] benzoic acid (whose structure is represented by the following Formula (4)) was used. Hereinafter, this photosensitive polymer is abbreviated as a photosensitive polymer A.

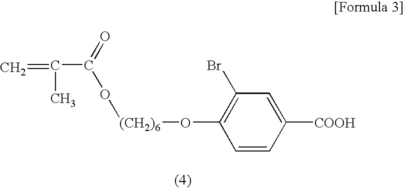

As shown in FIG. 4, the photosensitive polymer A exhibits maximum absorption with respect to light having a wavelength of about 410 nm. This absorption is caused by the first side chain. The photosensitive polymer A hardly absorbs light having a wavelength of about 655 nm and about 800 nm. Further, since the photosensitive polymer A dose not have a crystal structure, there is little optical transmission loss due to scattering. The transmittance of the recording layer made of the photosensitive polymer A with respect to laser light having a wavelength of 800 nm is about 100% except for reflected light from a surface of the recording layer.

Next, the relationship between the amount of light irradiated to the photosensitive polymer A and the absorptance of the photosensitive polymer A with respect to the irradiated light was examined. The result is shown in FIG. 5. The laser light had a wavelength of 800 nm.

In FIG. 5, a horizontal axis represents the amount (nJ/μm²) of irradiated light at a focal point where the light is converged by an objective lens, and a vertical axis represents the light absorptance (%) of the recording layer (thickness: 1 μm) made of the photosensitive polymer A except for a reflection loss from the surface of the recording layer. The laser light had a pulse width of 100 femtoseconds (10-13 seconds) so as to suppress the influence of heat generation.

As shown in FIG. 5, when the amount of irradiated light was not more than 100 nJ/μim², the recording layer absorbed no light. However, when the amount of irradiated light was more than 100 nJ/μm², the light absorptance increased sharply.

Further, as shown in FIG. 5, when the amount of irradiated light was 250 nJ/μIm², the light absorptance was about 0.5%, and when the amount of irradiated light was 500 nJ/μm², the light absorptance was about 2%. That is to say, in this region, a twofold increase in the amount of irradiated light resulted in a fourfold increase in the light absorptance. From this result, it was found that the recording layer containing the photosensitive polymer A allowed two-photon absorption to occur when the amount of irradiated light was more than 100 nJ/μm².

Electrons excited by two-photon absorption exhibit the following phenomenon. That is, (1) electrons are transformed into heat by colliding with a lattice and return to a normal unexcited state, or (2) electrons emit light having half the wavelength of the excited light and return to an unexcited state. When the phenomenon (1) occurs, the light absorptance of the recording layer containing the photosensitive polymer A should not be changed greatly even when the wavelength of the laser light is changed. However, as shown in FIG. 4, the photosensitive polymer A exhibits high absorption with respect to light having a wavelength of about 400 nm. Thus, when the recording layer is irradiated with recording light having a wavelength of, for example, 800 nm, electrons are excited by converged light having a wavelength of 800 nm (the amount of irradiated light in a focusing portion of the recording layer is, for example, more than 100 nJ/μm²), and the excited electrons emit light having a wavelength of 400 nm and then return to an unexcited state. This is understood as if light having a wavelength of 400 nm were absorbed in the first side chain. When such a phenomenon occurs with respect to the first side chain, the first side chain undergoes a cis-trans isomerization reaction (form change).

When being converted into a trans-form, the first side chain is oriented in a stable direction in which it does not react with an optical electric field and in an unstable direction in which it is likely to react with the optical electric field. A trans-form oriented in the direction in which the first side chain reacts with the optical electric field returns to a cis-form with the passage of time, and the first side chain returned to a cis-form is converted into a trans-form again with light. After the repetition of this cycle, the first side chain is finally oriented uniformly in the direction in which it does not react with the optical electric field (Weigert effect).

On the other hand, due to the form change of the first side chain, the second side chain has its major axis oriented in about the same direction as that of a major axis of the first side chain that is oriented uniformly.

Consequently, a great change in the refractive index (birefringence) occurs with respect to the recording layer, thereby allowing information to be recorded therein.

With respect to the photosensitive polymer used in the information recording medium of the present invention, the first side chain is converted from a cis-form to a trans-form at about the same speed as that of the reverse reaction thereto. Such speeds are higher than the speed of phase change, and particularly much higher than the speed of change from an amorphous phase to a crystalline phase. That is to say, the information recording medium of the present embodiments for which the above-mentioned photosensitive polymer is used as a recording material has a higher information recording speed and information erasing speed than those of a phase-change type information recording medium.

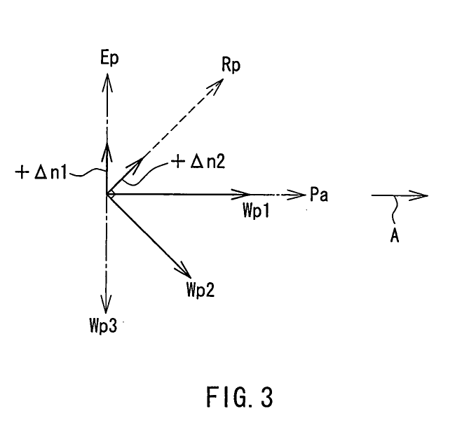

Further, when the amount of irradiated light is lower than a predetermined value, e.g., 100 nJ/μm² or lower, the photosensitive polymer is substantially transparent with respect to light having a wavelength of 800 nm (see FIG. 3). Thus, when recording light having a wavelength of, for example, 800 nm is focused on any of a plurality of recording layers, recording layers other than the recording layer on which the recording light is focused are substantially transparent with respect to the recording light.

From the above, the information recording medium of the present embodiments enables three-dimensional recording and allows information recording and erasing to be performed at a higher speed than that of a phase-change type information recording medium.

The photosensitive polymer has its light absorption region (absorption wavelength) almost unchanged before and after information is recorded. Therefore, a light source for emitting recording light and a light source for emitting reproduction light may have the same wavelength. When the recording light and the reproduction light have the same wavelength, an optical system of an information recording/reproducing apparatus requires only one light source, thereby simplifying the configuration of the optical system.

In the information recording medium of the present embodiments, it is preferable that a stilbene-based compound is bonded to at least one of the first side chain and the second side chain. Preferably, the stilbene-based compound is bonded to any one of the above-mentioned X1, X2, and R1 to R8.

The stilbene-based material is represented by the following Formulas (5) to (9), for example.

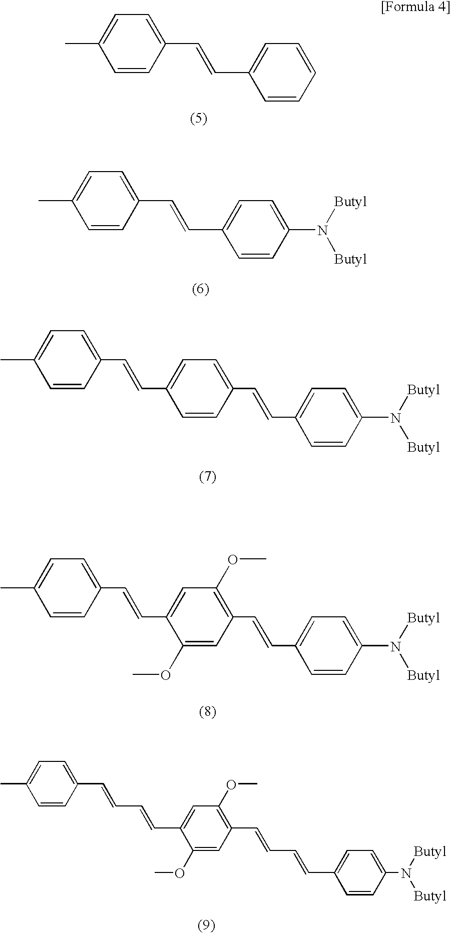

Each of the stilbene-based compounds has a high two-photon absorption coefficient (two-photon absorption cross section). Thus, when this stilbene-based compound is bonded to at least one of the first side chain and the second side chain, a cis-trans isomerization reaction occurs easily, thereby increasing the recording sensitivity. If the photosensitive polymer does not contain the above-mentioned stilbene-based compound, about several mJ/μm² of light irradiation is required to record information by two-photon absorption. However, when the photosensitive polymer contains the above-mentioned stilbene-based compound, only about several hundred nJ/μm² of light irradiation enables recording.

The above-mentioned stilbene-based compounds can be manufactured by a method described in documents (see, for example, “Photoaddressable Polymers for Rewritable Optical Disc System” written by Y. Sabi, M. Yamamoto, H. Watanabe, eta Proceedings of ISOM 2000).

An exemplary information recording medium of the present invention preferably includes a plurality of recording layers, which are laminated with separation layers that are substantially transparent with respect to recording light and reproduction light interposed therebetween. In the present specification, being substantially transparent with respect to recording light and reproduction light means that recording light and reproduction light except for their scattered components can be transmitted almost without being absorbed. Specifically, the light transmittance per one layer is preferably not less than 95%, and more preferably not less than 99%.

A manufacturing process of the information recording medium of the present invention includes, for example, a process of applying a coating containing a photosensitive polymer onto a substrate. In the information recording medium thus produced, an optic axis of the photosensitive polymer (recording layer) is oriented randomly, and the recording layer containing the photosensitive polymer is nearly isotropic optically. Although the information recording medium of the present invention can be used as it is, it may be initialized so that the photosensitive polymer becomes uniaxially anisotropic. When the information recording medium is initialized so that the photosensitive polymer has an optic axis oriented in a single direction, it is possible to obtain a higher recording signal than that of an information recording medium in which the photosensitive polymer is nearly isotropic optically.

In a recording/reproducing method and an information recording/reproducing apparatus of the present invention, “substantially 45 degrees” is a description given to include a margin of error, and specifically suggests 45 degrees ±10 degrees. An error of about ±10 degrees can be canceled or corrected by a circuit system of the information recording/reproducing apparatus. Also, “substantially 90 degrees” is a description given to include a margin of error, and specifically suggests 90 degrees +15 degrees. An error of about ±15 degrees can be canceled or corrected by a circuit system of the information recording/reproducing apparatus.

In an exemplary recording/reproducing method of the present invention, it is preferable that recording light includes first light and second light, the second light has its polarization plane direction tilted substantially 45 degrees with respect to a polarization plane direction of the first light, and reproduction light has its polarization plane direction tilted substantially 90 degrees with respect to the polarization plane direction of one of the first light and the second light.

In an exemplary recording/reproducing method of the present invention, it is preferable that the recording light and the reproduction light have the same wavelength.

In an exemplary information recording/reproducing apparatus of the present invention, it is preferable that a light source for emitting recording light and a light source for emitting reproduction light have the same wavelength.

An exemplary information recording/reproducing apparatus of the present invention preferably includes a light source for emitting erasure light.

### Embodiment 1

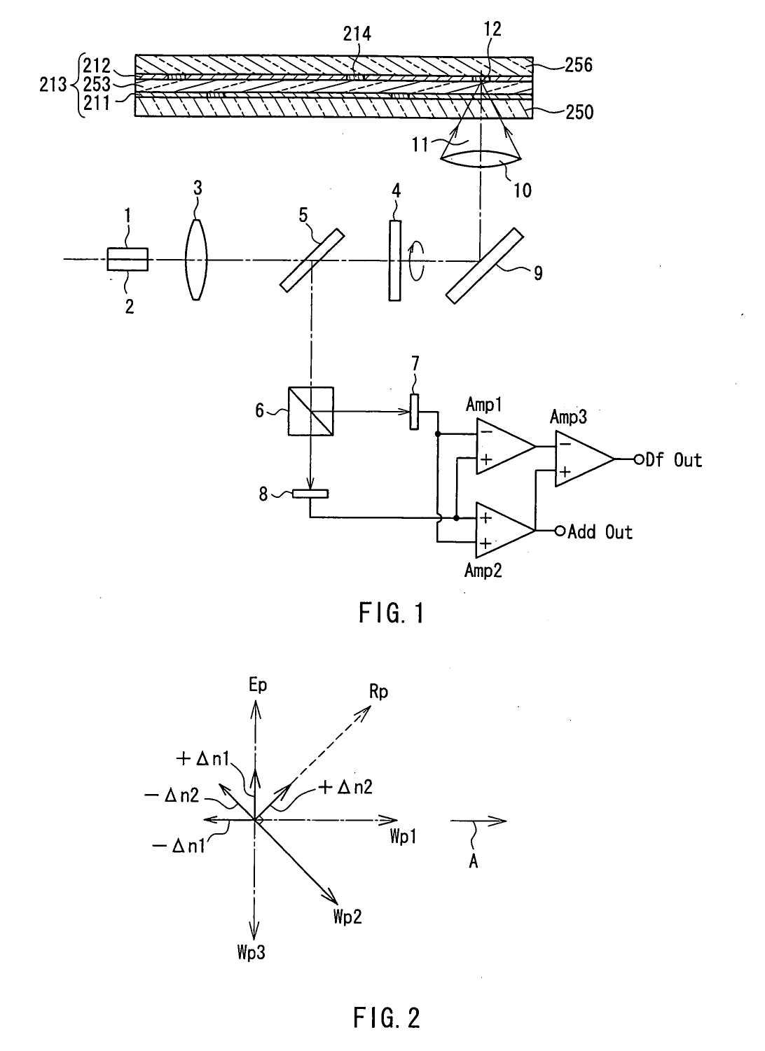

An information recording medium, a recording/reproducing method for the same, and an information recording/reproducing apparatus according to Embodiment 1 will be described with reference to FIGS. 1 and 2.

FIG. 1 is a view showing a cross-sectional configuration of an exemplary information recording medium and a schematic configuration of an optical head of an information recording/reproducing apparatus of the present invention. FIG. 2 is a diagram showing polarization plane directions of recording light and reproduction light irradiated to an information recording medium A described later. FIG. 3 is a diagram showing polarization plane directions of recording light and reproduction light irradiated to an information recording medium B described later.

As shown in FIG. 1, in the information recording medium of the present embodiment, a recording part 213 and a protective layer 250 are formed on a support substrate 256. The recording part 213 includes recording layers 211 and 212 and a separation layer 253 arranged therebetwen, which are laminated alternately. The information recording medium of the present embodiment includes the plurality of recording layers 211 and 212 in the recording part 213, thereby enabling information to be recorded in a thickness direction in addition to a plane direction.

As shown in FIG. 1, in the information recording medium of the present embodiment, in recording and reproducing information, light is incident from the side of the protective layer 250. In recording, laser light is focused (converged light 11) on either one of the recording layers 211 and 212 by an objective lens 10, thereby forming a recorded bit 214. In reproduction, laser light is focused (converged light 7) on a desired recording layer by the objective lent 10, thereby reproducing information using light reflected by the recorded bit 214.

In the information recording medium of the present embodiment, before information is recorded (before use), an optic axis of a photosensitive polymer or a second side chain may be oriented randomly, and the recording layers may be nearly isotropic optically (hereinafter, the information recording medium of this configuration is also referred to as an information recording medium A). Alternatively, the information recording medium may be initialized so that the photosensitive polymer has an optic axis oriented in a single direction (hereinafter, the information recording medium of this configuration is also referred to as an information recording medium B). The information recording medium can be initialized by, for example, irradiating the recording layers with light having a predetermined polarization plane direction. For example, after forming the recording layers by applying a coating containing a photosensitive polymer onto the substrate, the information recording medium is rotated while the recording layers are irradiated with light having a polarization plane direction tilted 90 degrees (orthogonal) with respect to a radial direction of the information recording medium. As a result, the optic axis is allowed to be oriented uniformly in the radial direction of the information recording medium. (A) Next, a description will be given of the recording/reproducing method of the present embodiment for recording or reproducing information with respect to the information recording medium A, a method for erasing information, and the information recording/reproducing apparatus of the present embodiment.

A light source 1 for emitting recording light shown in FIG. 1 is, for example, a semiconductor laser having a wavelength of 800 nm, and a light source 2 for emitting reproduction light is, for example, a semiconductor laser having a wavelength of 655 nm. Initially, the recording light (laser light) having a wavelength of 800 nm that is emitted from the light source 1 is collimated by a collimator lens 3. Then, the collimated light passes through a half mirror 5 and a half-wave plate (crystal) 4.

In recording, a predetermined polarization plane direction (e.g., a direction Wp1 in FIG. 2) of the laser light is made to coincide with an optic axis of the half-wave plate 4, so that the half-wave plate 4 has no effect on the laser light, for example.

When the half-wave plate 4 is rotated so that the optic axis of the half-wave plate 4 deviates from the polarization plane direction of the laser light, the polarization plane direction of the laser light turns to (coincides with) the optic axis of the half-wave plate when the laser light passes through the half-wave plate. It is also possible to emit recording light having a polarization plane direction Wp1 (see FIG. 2) from the light source and adjust the angle of rotation of the half-wave plate 4 so that the laser light has a polarization plane direction Wp2 (see FIG. 3), whereby information is recorded by using the recording light whose polarization plane direction is controlled to the direction Wp2. In this case, the polarization plane direction Wp2 is tilted substantially 45 degrees with respect to the polarization plane direction Wp1 (predetermined direction).

In this manner, when the recorded bit is formed in the same recording layer by using both the recording light having the polarization plane direction Wp1 (first light) and the recording light having the polarization plane direction Wp2 (second light), multiple recording can be performed, and the recording density can be increased to twice as high as that in the case of recording information by using either one of the first light and the second light.

When the polarization plane direction of the recording light is changed by rotating the half-wave plate, light having either one of the polarization plane directions Wp1 and Wp2 is irradiated first, and light having the other polarization plane direction is irradiated thereafter. However, there is no limitation thereto, and the first light and the second light may be irradiated at the same time. In such a case, two light sources for emitting recording light are used, one emitting the recording light having the polarization plane direction Wp1 and the other emitting the recording light having the polarization plane direction Wp2.

In FIG. 2, the polarization plane direction (direction Wp1 ) of the recording light coincides with a radial direction A of the information recording medium. However, there is no limitation thereto. Further, it is not necessarily required that the polarization plane direction of the recording light emitted from the light source 1 coincides with the optic axis of the half-wave plate. Instead, it is also possible that the recording light that has passed through the half-wave plate has a predetermined polarization plane direction, e.g., the direction Wp1 by rotating the half-wave plate 4.

As shown in FIG. 1, light incident on a polarization beam splitter 6 is split into two types of light beams having different polarization plane directions. When the polarization beam splitter 6 is arranged so that a direction of one output from the polarization beam splitter 6 coincides with the polarization plane direction of either one of the first light and the second light, light (reproduction light) reflected by the information recording medium is split into light beams in two directions having polarization plane directions that form an angle of 90 degrees with respect to each other. However, in order to split light (reproduction light) reflected by the information recording medium into light beams in two directions having polarization plane directions that form an angle of 90 degrees with respect to each other, it is required that the polarization plane direction of the reproduction light is tilted substantially 90 degrees with respect to the polarization plane direction of either one of the first light and the second light. By satisfying this requirement, as described later, it is possible to obtain from a multiply recorded bit a signal capacity that is twice as high as that obtained from a bit recorded by using either one of the first light and the second light.

In information recording, the diameter of light focused on the recording layer 212 is about 0.45 μm in the case where the objective lens 10 has a numerical aperture (NA) of 0.85, for example. When the distance between the recording layer 211 and the recording layer 212 is, for example, 5 μm, the minimum diameter of the light passing through the recording layer 211 is about 16 μm. Accordingly, the amount of light irradiated to the recording layer 211 per unit area is not more than about (0.45/16)² (not more than about 1/1000) of that in the recording layer 212. As shown in FIG. 5, when the amount of light irradiated to the recording layer 212 is, for example, 500 (nJ/μm²), the amount of light irradiated to the recording layer 211 is not more than about 1/1000 of the above, i.e., 0.5 (nJ/μm²). The light absorptance of the recording layer 211 is approximately 0%. Therefore, it is possible to provide an information recording medium that includes 10 or more, and further 100 or more recording layers and enables three-dimensional recording.

When the recorded bit 214 (see FIG. 1) is formed by recording light having the polarization plane direction Wp1, in the recorded bit 214, a part of a photosensitive polymer (second side chain) that has been oriented in the same direction as the direction Wp1 before the formation of the recorded bit is oriented in a direction perpendicular to the direction Wp1, i.e., a direction Ep as shown in FIG. 2. Accordingly, the refractive index from the direction Ep increases by about Δn1, for example. On the other hand, since the photosensitive polymer (second side chain) that has been oriented in the same direction as the direction Wp1 is reduced, the refractive index from the direction Wp1 decreases by about Δn1 (represented as—Δn1 in FIG. 2). The difference in the refractive index between a region (recorded bit 214) in which the recorded bit is- formed and a region in which no recorded bit is formed is approximately 0.05 to 0.25, for example.

On the other hand, when the recorded bit is formed by recording light having the polarization plane direction Wp2, in the recorded bit, a part of a photosensitive polymer (second side chain) that has been oriented in the same direction as the direction Wp2 before the formation of the recorded bit is oriented in a direction perpendicular to the direction Wp2, i.e., a direction Rp. Accordingly, the refractive index from the direction Rp increases by about Δn2, for example. On the other hand, since the photosensitive polymer (second side chain) that has been oriented in the same direction as the direction Wp2 is reduced, the refractive index from the direction Wp2 decreases by about Δn2 (represented as—Δn2 in FIG. 2).

Next, a method for reproducing a recorded mark will be described.

Laser light emitted from the light source 2 (oscillation wavelength: 655 nm; see FIG. 1) for emitting reproduction light is collimated by the collimator lens 3. The half-wave plate 4 is rotated so that the reproduction light (laser light) at this time has a polarization plane direction that is tilted 45 degrees with respect to the polarization plane direction Wp1 (see FIG. 2) of recording light and about 90 degrees with respect to the polarization plane direction Wp2 (see FIG. 2) of recording light.

In the present embodiment, the polarization plane direction of the reproduction light is controlled by rotating the half-wave plate 4 through a predetermined angle. However, there is no limitation thereto. For example, by locating the light source for emitting reproduction light at a predetermined position, it is also possible to have the polarization plane direction of the reproduction light tilted 90 degrees with respect to either one of the polarization plane direction Wp1 (see FIG. 2) and the polarization plane direction Wp2 (see FIG. 2).

After that, the reproduction light is focused on the recording layer 212 by the objective lens 10. Then, reflected light from the recorded bit 214 is returned-to parallel light by the objective lens 10, and a part of the parallel light is bent perpendicularly by the half mirror 5 to be introduced to the polarization beam splitter 6. The reflected light is split into light beams having the polarization plane directions Wp1 and Ep, respectively, by the polarization beam splitter 6, and the split light beams are introduced to photodetectors 7 and 8, respectively. The photodetectors 7 and 8 are located at positions that enable reception of the light beams having the polarization plane directions Wp1 and Ep, respectively.

Next, output from each of the photodetectors 7 and 8 will be described.

As described above, when the recorded bit is formed by the recording light having the polarization plane direction Wp1, with respect to a signal output from the photodetector 7 that has received the light having the polarization plane direction Wp1, the refractive index is Δn1 lower than that obtained when light is reflected in a region in which no recorded bit is formed. On the other hand, with respect to a signal output from the photodetector 8 that has received the light having the polarization plane direction Ep, the refractive index is Δn1 higher than that obtained when light is reflected in a region in which no recorded bit is formed. In other words, with respect to the refractive index, the signals output from the photodetectors 7 and 8, respectively, are detected as being in antiphase with each other.

These signals with respect to the refractive index are output through Amp 1 and Amp 2. The Amp 1, which is a differential amplifier, adds the signals output from the photodetectors 7 and 8 together, thereby obtaining a signal from DfOut. The Amp 2, which is a summing amplifier, cancels the signals output from the photodetectors 7 and 8 each other, thereby obtaining no signal from AddOut.

When the recorded bit is formed by recording light having the polarization plane direction Wp2, in a region of the recording layer in which the recorded bit is formed, a part of a photosensitive polymer (second side chain) that has been oriented in the same direction as the direction Wp2 before the formation of the recorded bit is oriented in a direction perpendicular to the direction Wp2, i.e., a direction Rp. Accordingly, the refractive index from the direction Rp increases by about Δn2, for example. On the other hand, since the photosensitive polymer (second side chain) that has been oriented in the same direction as the direction Wp2 is reduced, the refractive index from the direction Wp2 decreases by about Δn2. When the reflected light is split by the polarization beam splitter 6 into light beams having the polarization plane directions Wp1 and Ep, respectively, an increase and a decrease in the refractive index also are detected separately. With respect to the light having the polarization plane direction Wp1, the refractive index decreases by the same amount as an increase in the refractive index of Δn2×cos 45. Thus, no change in the refractive index is detected from the light having the polarization plane direction Wp1. A change in the refractive index is detected only from the light having the polarization plane direction Ep.

Therefore, no signal is output from the photodetector 7 for detecting a signal included in the light having the polarization plane direction Wp1, and a signal is output only from the photodetector 8 for detecting a signal included in the light having the polarization plane direction Ep. In this case, it is possible to obtain signals from both the differential amplifier Amp 1 and the summing amplifier Amp 2, and thus obtain signals from both the DfOut and the AddOut. However, an amplifier Amp 3 (not shown) may be provided to take an appropriate amount of difference from the differential amplifier Amp 1 and the summing amplifier Amp 2, so that no signal is obtained from the DfOut. In such a case, a signal is obtained from the AddOut, and no signal is obtained from the DfOut.

As described above, from the bit multiply recorded by using both the first light having the polarization plane direction Wp1 and the second light having the polarization plane direction (Wp2) that is tilted 45 degrees with respect to the direction Wp1, a signal that is twice as high as that obtained from a bit recorded by using either one of the first light and the second light can be obtained.

Next, erasure of the recorded bit will be described.

The recorded bit can be erased by allowing the optic axis of the photosensitive polymer to be oriented randomly. Thus, circularly polarized light is used as erasure light. Circularly polarized light allows the optic axis of the photosensitive polymer to be rotated in a different direction, whereby the photosensitive polymer becomes isotropic as a whole. An amorphous polymer with no orientation does not show birefringence, and thus allows the recorded bit to be erased. Further, it is also possible to use randomly polarized light as erasure light or apply heat, so that a plurality of recorded bits formed in a recording layer can be deleted at a time. (B) Next, a description will be given of the recording/reproducing method of the present embodiment for recording or reproducing information with respect to the information recording medium B, a method for erasing information, and the information recording/reproducing apparatus of the present embodiment.

In the information recording medium B, a photosensitive polymer has an optic axis in a single direction as shown in FIG. 3, for example. The optic axis is oriented in a direction Pa, for example. Thus, when the polarization plane direction of either one of the first light having the polarization plane direction Wp1 and the second light having the polarization plane direction Wp2 is made to coincide with the optic axis oriented in the direction Pa, it is possible to increase a change in the refractive index of the recording layer that accompanies recording. In an example shown in FIG. 3, the polarization plane direction (direction Wp1) of the first light coincides with the direction Pa. In recording information on the information recording medium B, the polarization plane direction of the second light also is tilted substantially 45 degrees with respect to the direction Wp1 as in the case of recording information with respect to the information recording medium A.

The difference in the refractive index between a region (recorded bit 214) in which the recorded bit is formed and a region in which no recorded bit is formed is approximately 0.5, for example. The difference in the refractive index is larger than that in the information recording medium A since the optic axis is oriented in a single direction in an initial state.

From the bit multiply recorded by using both the first light having the polarization plane direction Wp 1 and the second light having the polarization plane direction (Wp2) that is tilted 45 degrees with respect to the direction Wp1 as described above, information is reproduced in the same manner as in the case of reproducing information recorded on the information recording medium A. Thus, a description thereof will be omitted.

Next, erasure of the recorded bit will be described.

The recorded bit can be erased by allowing the optic axis of the photosensitive polymer to be oriented in the direction Pa. As erasure light, laser light having a polarization plane direction orthogonal to the direction Pa, i.e., laser light having a polarization plane direction Ep is used. When laser light having a polarization plane direction orthogonal to the direction Pa is irradiated, the optic axis of the photosensitive polymer is returned to its initial state where it is oriented uniformly in the Pa direction.

### Embodiment 2

In an information recording medium of Embodiment 2, as a photosensitive polymer, a photosensitive polymer C in which a stilbene-based compound (5) to (9) in [Formula 4] is bonded to a photosensitive polymer B containing 3-bromo-4-[6-(2-methylpropenoyl) hexoxy] benzoic acid 4′-cyano-2′, 6′-dibromophenyl (whose structure is represented by the following Formula (10)) is used. Except for this point, the information recording medium of Embodiment 2 is the same as that in Embodiment 1. The following Formula (11) represents a state in which the stilbene-based compound (6) is bonded to 3-bromo-4-[6-(2-methylpropenoyl) hexoxyl] benzoic acid 4′-cyano-2′, 6′-dibromophenyl.

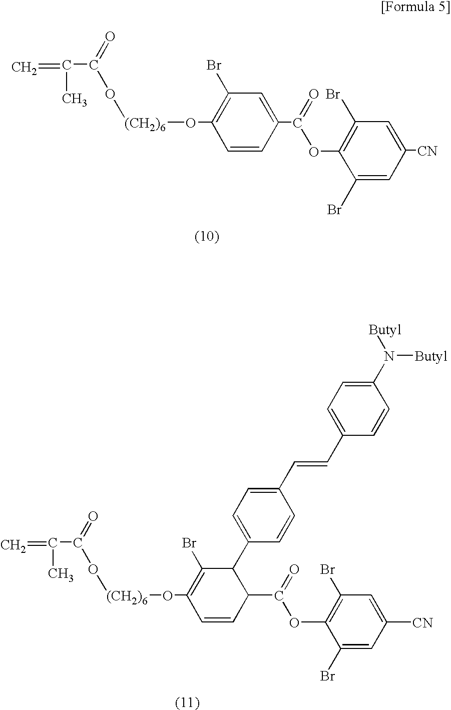

The photosensitive polymer C containing the stilbene-based compound (6) has a maximum absorption wavelength λmax of 430 nm. On the other hand, the photosensitive polymer B has a maximum absorption wavelength λmax of 380 nm. Further, the photosensitive polymer containing the stilbene-based compound (5) has a maximum absorption wavelength λmax of 400 nm. It was found that the maximum absorption wavelength increased with the length (length of a major axis) of a stilbene-based compound.

The photosensitive polymer C containing the stilbene-based compound (6) had a two-photon absorption cross section of approximately 100 GMR (GMR=10⁻⁵ cm⁻¹s·photon −1). On the other hand, the photosensitive polymer B had a two-photon absorption cross section of 1 GMR. Further, the photosensitive polymer C containing the stilbene-based compound (5) had a two-photon absorption cross section of 25 GMR, the photosensitive polymer C containing the stilbene-based compound (7) had a two-photon absorption cross section of 150 GMR, and the photosensitive polymer C containing the stilbene-based compound (8) had a two-photon absorption cross section of 250 GMR. From the above results, it was found that the two-photon absorption cross section increased with the length (length of a major axis) of a stilbene-based compound. A larger two-photon absorption cross section allows a higher recording sensitivity to be obtained.

However, when the major axis of a stilbene-based compound is too long, the maximum absorption wavelength of the photosensitive polymer becomes too high. For example, the photosensitive polymer containing the stilbene-based compound (8) has a maximum absorption wavelength of 800 nm. When the absorption wavelength of the photosensitive polymer is too high, the recording density is decreased. In terms of high-density recording, it is preferable that λmax is approximately 400 nm at the maximum.

Thus, in view of both the recording sensitivity and the recording density, it is preferable that the stilbene-based compound (6) in [Formula 3] in particular is bonded to either one of a first chain and a second chain.

Since the maximum absorption wavelength of the photosensitive polymer C containing the stilbene-based compound (6) is 430 nm, an optimum wavelength of recording light is 860 nm. It was found from the result of a simulation in a molecular orbital analysis that when information is recorded by two-photon absorption using recording light having a wavelength of 800 nm, for example, the recording sensitivity of an information recording medium using the photosensitive polymer C is increased to 80 times as high as that of an information recording medium using the photosensitive polymer B. Accordingly, even if output of a light source (semiconductor laser) for emitting recording light is relatively low at about 1.25 W, it is possible to record information.

### INDUSTRIAL APPLICABILITY

According to an information recording medium, a recording/reproducing method for the same, and an information recording/reproducing apparatus of the present invention, it is possible to provide an information recording medium, a recording/reproducing method for the same, and an information recording/reproducing apparatus that allow information to be recorded and erased at a high speed.

1. An information recording medium including a recording layer, in which information is recorded by two-photon absorption that occurs when recording light is focused on the recording layer,
wherein the recording layer contains a photosensitive polymer that includes a principal chain containing acrylate or methacrylate and a first side chain and a second side chain branched from the principal chain,
the first side chain undergoes a cis-trans isomerization reaction upon absorption of the recording light, and
the second side chain has a property of being oriented in about the same direction as a direction of the first side chain when the first side chain undergoes the cis-trans isomerization reaction.

2. The information recording medium according to claim 1, wherein a stilbene-based compound is bonded to at least one of the first side chain and the second side chain.

3. The information recording medium according to claim 2, wherein the stilbene-based compound has a structure represented by the following formula.

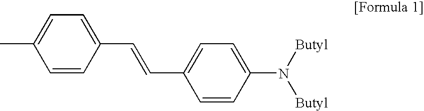

4. The information recording medium according to claim 1, wherein a plurality of recording layers are included, the recording layers being laminated with a separation layer that is substantially transparent with respect to the recording light and reproduction light interposed between the recording layers.

5. The information recording medium according to claim 1, wherein the photosensitive polymer has an optic axis oriented in a single direction.

6. A recording/reproducing method for recording or reproducing information with respect to the information recording medium according to claim 1, comprising:
focusing the recording light on the recording layer so as to form a recorded bit; and
irradiating the recorded bit with reproduction light so as to reproduce information.

7. The recording/reproducing method according to claim 6, wherein the recording light includes first light and second light, the second light has a polarization plane direction tilted substantially 45 degrees with respect to a polarization plane direction of the first light, and the reproduction light has a polarization plane direction tilted substantially 90 degrees with respect to the polarization plane direction of either one of the first light and the second light.

8. The recording/reproducing method according to claim 6, wherein the recording light and the reproduction light have the same wavelength.

9. A recording/reproducing method for recording or reproducing information with respect to the information recording medium according to claim 5, comprising:
focusing the recording light on the recording layer so as to form a recorded bit; and
irradiating the recorded bit with reproduction light so as to reproduce information,
wherein the recording light includes first light and second light, the second light has a polarization plane direction tilted substantially 45 degrees with respect to a polarization plane direction of the first light, and the polarization plane direction of either one of the first light and the second light coincides with the direction in which the optic axis of the photosensitive polymer is oriented, and
the reproduction light has a polarization plane direction tilted substantially 90 degrees with respect to the polarization plane direction of either one of the first light and the second light.

10. The recording/reproducing method according to claim 9, wherein the recording light and the reproduction light have the same wavelength.

11. An information recording/reproducing apparatus for recording or reproducing information with respect to the information recording medium according to claim 1, comprising:
a light source for emitting recording light;
a light source for emitting reproduction light;
a half-wave plate through which the recording light and the reproduction light pass; and
an objective lens for focusing the recording light and the reproduction light on the information recording medium,
wherein the half-wave plate can be rotated so that assuming that the recording light that has passed through the half-wave plate has a predetermined polarization plane direction, the recording light emitted from the light source has a polarization plane direction tilted substantially 45 degrees with respect to the predetermined polarization plane direction, and assuming that the predetermined polarization plane direction is a direction Wp1 and the polarization plane direction tilted substantially 45 degrees with respect to the predetermined polarization plane direction is a direction Wp2, the reproduction light emitted from the light source has a polarization plane direction tilted substantially 90 degrees with respect to either one of the polarization plane direction Wp1 and the polarization plane direction Wp2.

12. The information recording/reproducing apparatus according to claim 11, wherein the light source for emitting the recording light and the light source for emitting the reproduction light have about the same wavelength.

13. The information recording/reproducing apparatus according to claim 11, further comprising a light source for emitting erasure light.

14. An information recording/reproducing apparatus for recording or reproducing information with respect to the information recording medium according to claim 5, comprising:
a light source for emitting recording light;
a light source for emitting reproduction light;
a half-wave plate through which the recording light and the reproduction light pass; and
an objective lens for focusing the recording light and the reproduction light on the information recording medium,
wherein the half-wave plate can be rotated so that assuming that the recording light that has passed through the half-wave plate has a predetermined polarization plane direction, the recording light emitted from the light source has a polarization plane direction tilted substantially 45 degrees with respect to the predetermined polarization plane direction, and assuming that the predetermined polarization plane direction is a direction Wp1 and the polarization plane direction tilted substantially 45 degrees with respect to the predetermined polarization plane direction is a direction Wp2, either one of the polarization plane direction Wp1 and the polarization plane direction Wp2 coincides with the optic axis of the photosensitive polymer, and the reproduction light emitted from the light source has a polarization plane direction tilted substantially 90 degrees with respect to either one of the polarization plane direction Wp1 and the polarization plane direction Wp2.

15. The information recording/reproducing apparatus according to claim 14, wherein the light source for emitting the recording light and the light source for emitting the reproduction light have about the same wavelength.

16. The information recording/reproducing apparatus according to claim 14, further comprising a light source for emitting erasure light.
